(19) United States
(12) Patent Application Publication
(10) Pub. No.: US 2025/0390719 A1
(43) Pub. Date: Dec. 25, 2025

(54) GENERATING COMPUTING PLATFORM DASHBOARDS USING ARTIFICIAL INTELLIGENCE

(71) Applicant: Google LLC, Mountain View, CA (US)

(72) Inventor: Rishi Verma, Bangalore (IN)

(21) Appl. No.: 18/751,569

(22) Filed: Jun. 24, 2024

(51) Int. Cl. G06N 3/0475

(52) U.S. Cl. CPC G06N 3/0475

(57) ABSTRACT

A method for generating computing platform dashboards using AI includes obtaining, at a computing platform, first data associated with an entity that uses the computing platform. The first data indicates a category of the entity. The method includes generating dashboard content for the entity. Generating the dashboard content includes generating, using a trained AI model and based on the first data, one or more metrics associated with the computing platform. Generating the dashboard content includes obtaining, using a data store of the computing platform, one or more values for the one or more metrics associated with the computing platform. The one or more values correspond to the entity. The method includes causing display of a dashboard UI of the computing platform based on the dashboard content for the entity. The dashboard UI includes one or more visualizations each based on at least a portion of the one or more values.

### TECHNICAL FIELD

The instant specification generally relates to computing devices. More specifically, the instant specification relates to generating computing platform dashboards using artificial intelligence.

### BACKGROUND

Some computing platforms analyze data in order to provide users of the platform insights regarding the data. It can be helpful to the users to view the data using different types of visualizations (e.g., graphs, charts, tables, etc.). Thus, a computing platform may provide a dashboard on a user interface (UI) of the platform, and the dashboard may include one or more visualizations based on the analyzed data.

### SUMMARY

Disclosed herein are systems and methods for generating computing platform dashboards using artificial intelligence (AI). A method includes obtaining, at a computing platform, first data associated with an entity that uses the computing platform. The first data indicates a category of the entity. The method includes generating dashboard content for the entity. Generating the dashboard content includes generating, using a trained AI model and based on the first data, one or more metrics associated with the computing platform. Generating the dashboard content includes obtaining, using a data store of the computing platform, one or more values for the one or more metrics associated with the computing platform. The one or more values correspond to the entity. The method includes causing display of a dashboard user interface (UI) of the computing platform based on the dashboard content for the entity. The dashboard UI includes one or more visualizations each based on at least a portion of the one or more values.

Another aspect of the disclosure includes a system for generating computing platform dashboard using AI. The system includes a memory and a processor device coupled to the memory. The processor device is configured to perform one or more operations. The operations include includes obtaining, at a computing platform, first data associated with an entity that uses the computing platform. The first data indicates a category of the entity. The operations include generating dashboard content for the entity. Generating the dashboard content includes generating, using a trained AI model and based on the first data, one or more metrics associated with the computing platform. Generating the dashboard content includes obtaining, using a data store of the computing platform, one or more values for the one or more metrics associated with the computing platform. The one or more values correspond to the entity. The operations include causing display of a dashboard UI of the computing platform based on the dashboard content for the entity. The dashboard UI includes one or more visualizations each based on at least a portion of the one or more values.

Another aspect of the disclosure includes a method for generating computing platform dashboard using AI. The method includes obtaining, at a computing platform, first data associated with an entity that uses the computing platform. The first data indicates a category of the entity and a first set of metrics associated with the computing platform. The method includes generating dashboard content for the entity. Generating the dashboard content includes generating, using a trained AI model and based on the first data, a second set of metrics associated with the computing platform. Generating the dashboard content includes obtaining, using a data store of the computing platform, one or more values for the second set of metrics associated with the computing platform. The one or more values correspond to the entity. The method includes causing display of a dashboard UI of the computing platform based on the dashboard content for the entity. The dashboard UI includes one or more visualizations each based on at least a portion of the one or more values.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 schematically illustrates an example system for generating computing platform dashboards using artificial intelligence (AI) in which some aspects of the present disclosure may be implemented, in accordance with various embodiments.

FIG. 2 schematically illustrates an AI training subsystem for generating computing platform dashboards using AI in which some aspects of the present disclosure may be implemented, in accordance with various embodiments.

FIG. 3 schematically illustrates an AI inference subsystem for generating computing platform dashboards using AI in which some aspects of the present disclosure may be implemented, in accordance with various embodiments.

FIG. 4 depicts a flowchart illustrating an example method for practicing some aspects of the present disclosure, in accordance with various embodiments.

FIG. 5 depicts a flowchart illustrating another example method for practicing some aspects of the present disclosure, in accordance with various embodiments.

FIG. 6 depicts a block diagram of an example computer device capable of generating computing platform dashboards using AI, in accordance with some implementations of the present disclosure.

### DETAILED DESCRIPTION

Some computing platforms analyze data in order to provide users of the platform insights regarding the data. It can be helpful to the users to view graphical representations of the data using different types of visualizations (e.g., graphs, charts, tables, etc.). Thus, a computing platform may provide a dashboard on a user interface (UI) of the platform, and the dashboard may include one or more visualizations based on the analyzed data.

The computing platform may allow users to customize the visualizations of the dashboard, which may include a user selecting which data the platform uses to generate a visualization. However, users of the platform may not know which specific portions of data would be useful for the user to see in a visualized form. This lack of knowledge may lead to the user experimenting with different data and different visualizations until the user finds the desired ones. This experimentation can use a significant amount of computing resources (e.g., graphical processing resources to generate the visualizations, data retrieval resources (e.g., database calls) to obtain the data used to generate the visualizations, etc.).

Aspects and implementations of the present disclosure address the above deficiencies, among others, by providing systems and methods for generating computing platform dashboards using artificial intelligence (AI). A computing platform can obtain data associated with an entity that uses the platform, and the data may include a category of the entity (e.g., e-commerce, banking, cloud services, etc.) or one or more metrics associated with the entity. The platform can generate dashboard content for the entity. Generating the dashboard content may include generating or predicting, using a trained AI model, one or more metrics. The metrics may include categories of data that a user belonging to the entity may have an interest in visualizing. The metrics may include categories of data tracked by the platform or otherwise associated with the platform. Generating the dashboard content may further include obtaining values for the one or more metrics. The values may correspond to the entity. The computing platform can cause display of a dashboard UI of the platform, and the dashboard UI may be based on the dashboard content for the entity. The dashboard UI may include one or more visualizations that are based on the values for the metrics.

The present disclosure overcomes several of the above-mentioned deficiencies. For example, by using a trained AI model to select the metrics used to generate visualizations, a user of the computing platform does not need to experiment with different metrics and different visualizations until the user finds the desired ones. Instead, the AI model automatically selects or predicts the metrics based on data associated with the entity.

In addition, some benefits of the present disclosure may provide a technical effect caused by or resulting from a technical solution to a technical problem. For example, one technical problem may relate to the wasted computing resources expended due to a user of the computing platform experimenting with different metrics and different visualizations until the user finds the desired ones. One of the technical solutions to the technical problem may include using an AI model to select or predict the metrics. As a consequence, use of the computing resources of the computing platform is reduced.

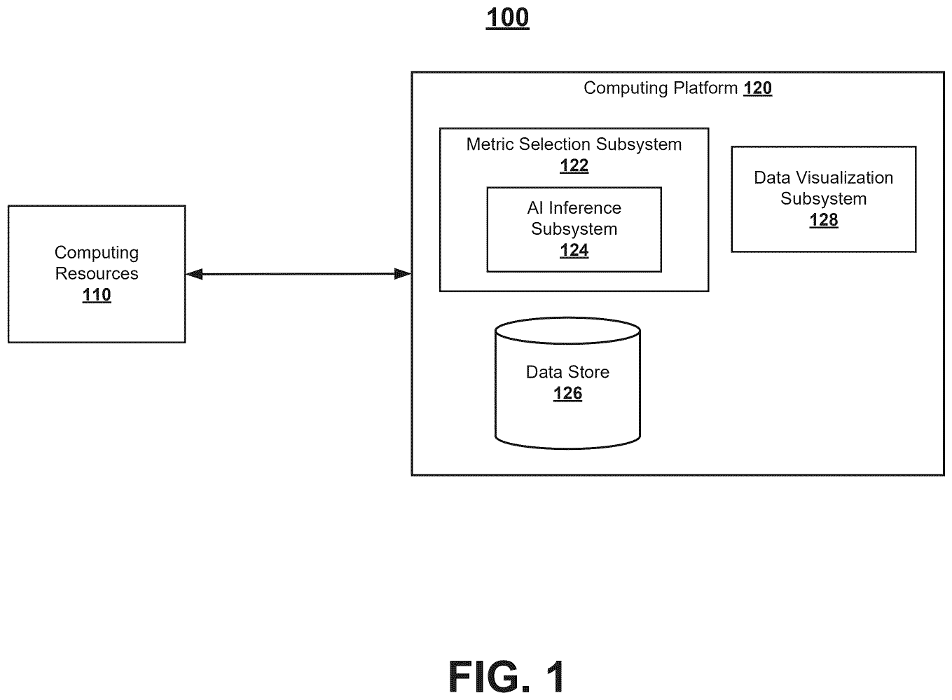

FIG. 1 depicts an example system 100 in which one or more aspects of the present disclosure are implemented, in accordance with some embodiments. The system 100 may include a system for generating computing platform dashboards using AI. The system 100 may include computing resources 110. The system 100 may include a computing platform 120. The computing platform 120 may include a metric selection subsystem 122, which may include an AI inference subsystem 124. The platform 120 may include a data store 126. The platform 120 may include a data visualization subsystem 128.

In one or more implementations, the computing resources 110 include a computing system. The computing resources 110 may include a computing system operated by a customer of the entity that operates the computing platform 120. The computing resources 110 may include one or more servers. A server may include a computing device. In some implementations, a computing device includes a physical computing device or includes a virtualized component, such as a virtual machine (VM) or a container. A computing device may include an instance of a computing device. An instance of a computing device may include a spun-up instance that may not be specific to any computing device. In some implementations, a VM may include a system virtual machine, which may include a VM that emulates an entire physical computing device. A VM can include a process virtual machine, which may include a VM that emulates an application or some other software. A container may include a computing environment that logically surrounds one or more software applications independently of other applications.

The computing resources 110 may include one or more network devices. A network device may include a switch, router, hub, gateway, wireless access point, bridge, modem, repeater, or another type of network device. A network device can help provide data communication between the one or more servers, between other devices of the computing resources 110, or between a computing device external to the computing resources 110 (e.g., a computing device of the computing platform 120) and a device of the computing resources 110. The computing resources 110 may include one or more data storage devices. A data storage device may include a data store. One or more servers or other computing devices of the computing resources 110 can store data on the one or more data storage devices or retrieve data from the one or more data storage devices.

In one or more implementations, the computing resources 110 and the computing platform 120 are in data communication with each other over a data network. The data network may include a local area network (LAN), wide area network (WAN), a virtual private network (VPN), or some other data network. The data network may include network devices, including switches, routers, hubs, gateways, wireless access points, bridges, modems, repeaters, or other network devices.

In one implementation, the computing resources 110 and the computing platform 120 execute on different computing systems. In other implementations, at least a portion of the computing resources 110 and the computing platform 120 execute on the same computing system. The computing system may include a cloud computing system. A cloud computing system may include one or more computing devices (or portions of cloud computing devices) provided to an end user by a cloud provider. An end user of the environment can utilize a portion of the cloud computing system to host content for use or access by other parties or perform other computational tasks. In some implementations, the cloud computing system may be configured to allow the end user to use a portion of a computing device (e.g., only certain hardware, software, or other computer system resources). The cloud computing environment may include a private cloud, a public cloud, or a hybrid cloud. The cloud computing environment can provide infrastructure-as-a-service (IaaS), platform-as-a-service (PaaS), or software-as-a-service (SaaS) computing. The cloud computing environment can provide serverless computing.

In implementations of the disclosure, a “user” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether the computing platform 120 collects user information (e.g., information about a user's social network, social actions or activities, profession, a user's preferences, or a user's current location), or to control whether and/or how to receive content from the computing platform 120 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the computing platform 120.

In some implementations, the computing platform 120 includes a security analytics platform. A security analytics platform may include a computing system configured to use data from the computing resources 110 (e.g., event logs, network traffic data, etc.) to detect threats to the computing resources 110 (e.g., by identifying suspicious patterns and potential breaches). The computing platform 120 may include a data analytics platform. A data analytics platform may include a computing system configured to ingest data from the computing resources 110, clean and organize the data, and provide tools to perform data analytics operations on the data. The computing platform 120 may include a business intelligence platform, which may include a data analytics platform that operates on business data (e.g., sales data, human resources data, etc.). The computing platform 120 may include some other type of computing system that analyzes data.

In one implementation, the metric selection subsystem 122 includes software configured to generate one or more metrics that the computing platform 120 can use to generate one or more visualizations for display on a dashboard UI of the platform 120. The one or more metrics may include categories of data that a user belonging to an entity that operates the computing resources 110 may have an interest in visualizing. For example, and as discussed in further detail below, a metric may include a number of unique visitors of a website, the geolocations of visitors of a website, or other metrics.

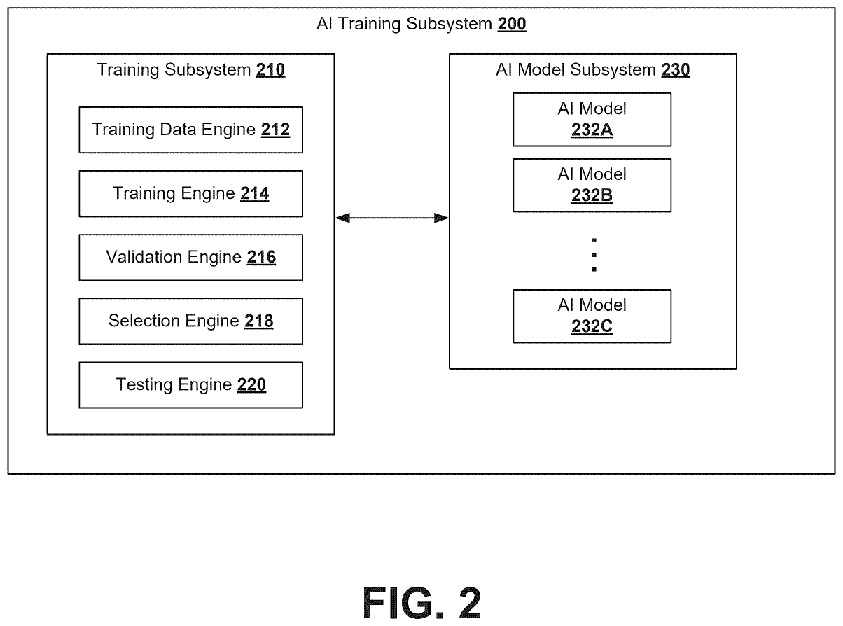

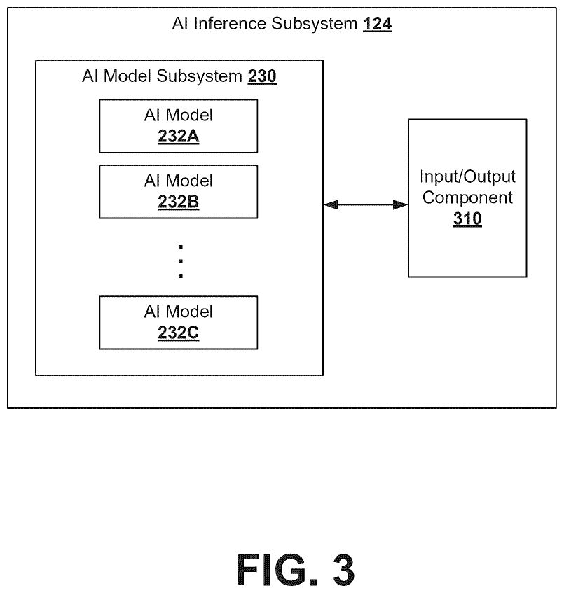

The metric selection subsystem 122 can use one or more AI models of the AI inference subsystem 124 to generate the one or more metrics. The AI inference subsystem 124 may include one or more AI models configured to generate the one or more metrics for the metric selection subsystem 122. Some details regarding the AI inference subsystem 124 and the one or more AI models are provided further below in relation to FIGS. 2-3.

In one implementation, the metric selection subsystem 122 uses the one or more metrics specified by the AI inference subsystem 124 to obtain one or more values corresponding to the one or more metrics from the data store 126. The metric selection subsystem 122 can provide the one or more metrics and the one or more values to the data visualization subsystem 128 to generate one or more visualizations of the metrics and values for display on a dashboard UI.

In one or more implementations, the data store 126 stores data obtained from the computing resources 110. The data store 126 can store data. The data may include values corresponding to metrics. The data store 126 may include a physical storage medium that can include volatile storage (e.g., random access memory (RAM), etc.) or non-volatile storage (e.g., a hard disk drive (HDD), flash memory, etc.). The data store 126 can include a file system, a database, or some other software configured to store data.

The data visualization subsystem 128, in some implementations, includes software configured to generate one or more visualizations based on at least a portion of the one or more values obtained by the metric selection subsystem 122. In some implementations, the data visualization subsystem 128 obtains the one or more metrics from the metric selection subsystem 122 and use the one or more metrics to obtain one or more values corresponding to the one or more metrics from the data store 126.

FIG. 2 illustrates an example AI training subsystem 200, in accordance with implementations of the present disclosure. As illustrated in FIG. 2, the AI training subsystem 200 can include a training subsystem 210, which may include a training data engine 212, a training engine 214, a validation engine 216, a selection engine 218, or a testing engine 220. The AI training subsystem 200 may include an AI model subsystem 230. The AI model subsystem 230 may include one or more AI models 232A-N.

In one implementation, the AI model 232 includes one or more artificial neural networks (ANNs), decision trees, random forests, support vector machines (SVMs), clustering-based models, Bayesian networks, or other types of machine learning models. ANNs generally include a feature representation component with a classifier or regression layers that map features to a target output space. The ANN can include multiple nodes (“neurons”) arranged in one or more layers, and a neuron can be connected to one or more neurons via one or more edges (“synapses”). The synapses can perpetuate a signal from one neuron to another, and a weight, bias, or other configuration of a neuron or synapse can adjust a value of the signal. Training the ANN may include adjusting the weights or other features of the ANN based on an output produced by the ANN during training.

An ANN may include, for example, a convolutional neural network (CNN), recurrent neural network (RNN), or a deep neural network (DNN). A CNN, a specific type of ANN, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). A DNN may include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that can be used is a long short term memory (LSTM) neural network.

ANNs can learn in a supervised (e.g., classification) or unsupervised (e.g., pattern analysis) manner. Some ANNs (e.g., such as DNNs) may include a hierarchy of layers, where the different layers learn different levels of representations that correspond to different levels of abstraction. In deep learning, each level learns to transform its input data into a slightly more abstract and composite representation.

In one implementation, an AI model 232 includes a generative AI model. A generative AI model can deviate from a machine learning model based on the generative AI model's ability to generate new, original data, rather than making predictions based on existing data patterns. A generative AI model can include a generative adversarial network (GAN), a variational autoencoder (VAE), or a large language model (LLM). In some instances, a generative AI model can employ a different approach to training or learning the underlying probability distribution of training data, compared to some machine learning models. For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

Generative AI models also have the ability to capture and learn complex, high-dimensional structures of data. One aim of generative AI models is to model underlying data distribution, allowing them to generate new data points that possess the same characteristics as training data. Some machine learning models (e.g., that are not generative AI models) focus on optimizing specific prediction of tasks. A generative AI model can generate new and original content. The generative AI model can use other machine learning models including an encoder-decoder architecture including one or more self-attention mechanisms, and one or more feed-forward mechanisms. In some implementations, the generative AI model includes an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model can also utilize the previously discussed deep learning techniques, including RNNs, CNNs, or transformer networks. Further details regarding generative AI models are provided herein.

In some implementations, an AI model 232 is an AI model that has been trained on a corpus of data. In some implementations, the AI model 232 can be a model that is first pre-trained on a corpus of data to create a foundational model, and afterwards fine-tuned on more data pertaining to a particular set of tasks to create a more task-specific, or targeted, model. The foundational model can first be pre-trained using a corpus of data that can include data in the public domain, licensed content, and/or proprietary content. Such a pre-training can be used by the AI model 232 to learn broad elements including, image or speech recognition, general sentence structure, common phrases, vocabulary, natural language structure, and other elements. In some implementations, this first, foundational model is trained using self-supervision, or unsupervised training on such datasets.

In some implementations, the AI model 232 is then further trained or fine-tuned on organizational data, including proprietary organizational data. The AI model 232 can also be further trained or fine-tuned on organizational data associated with event logs, network traffic, or other data associated with the computing resources 110.

In some implementations, the second portion of training, including fine-tuning, may be unsupervised, supervised, reinforced, or any other type of training. In some implementations, this second portion of training includes some elements of supervision, including learning techniques incorporating human or machine-generated feedback, undergoing training according to a set of guidelines, or training on a previously labeled set of data, etc. In a non-limiting example associated with reinforcement learning, the outputs of the AI model 232 while training can be ranked by a user, according to a variety of factors, including accuracy, helpfulness, veracity, acceptability, or any other metric useful in the fine-tuning portion of training. In this manner, the AI model 232 can learn to favor these and any other factors relevant to users when generating a response. Further details regarding training are provided below.

In some implementations, an AI model 232 includes one or more pre-trained models, or fine-tuned models. In a non-limiting example, in some implementations, the goal of the “fine-tuning” is accomplished with a second, or third, or any number of additional models. For example, the outputs of the pre-trained model can be input into a second AI model that has been trained in a similar manner as the “fine-tuned” portion of training above. In such a way, two more AI models can accomplish work similar to one model that has been pre-trained, and then fine-tuned.

In some implementations, different AI models 232 of the one or more AI models are different types of AI models. Multiple AI models 232 of the one or more AI models 232A-N can form an ensemble.

In one implementation, the training subsystem 210 manages the training and testing of the one or more AI models 232A-N. The training data engine 212 can generate training data (e.g., a set of training inputs and a set of target outputs) to train an AI model 232. In an illustrative example, the training data engine 212 can initialize a training set T to null. The training data engine 212 can generate training data that includes categories of entities and one or more metrics as training inputs and includes one or more metrics as target outputs. The training data engine 212 can add the training data to the training set T and can determine whether the training set T is sufficient for training the AI model 232. The training set T can be sufficient for training the AI model 232 if the training set T includes a threshold amount of training data, in some implementations. In response to determining that the training set T is sufficient for training, the training data engine 212 can provide the training set T to the training engine 214.

The training engine 214 can train the AI model 232 using the training data (e.g., training set T). The AI model 232 can refer to the model artifact that is created by the training engine 214 using the training data, where such training data can include training inputs and, in some implementations, corresponding target outputs (e.g., correct answers for respective training inputs). The training engine 214 can input the training data into the AI model 232 so that the AI model 232 can find patterns in the training data and configure itself based on those patterns.

Where the AI model 232 uses supervised learning, the training engine 214 can assist the AI model 232 in determining whether the AI model 232 maps the training input to the target output (the answer to be predicted). Where the AI model 232 uses unsupervised learning, the training engine 214 can input the training data into the AI model 232. The AI model 232 can configure itself based on the input training data, but since the training data may not include a target output, the training engine 214 may not assist the AI model 232 in determining whether the AI model 232 provided a correct output during the training process.

The validation engine 216 can be capable of validating a trained AI model 232 using a corresponding set of features of a validation set from the training data engine 212. The validation engine 216 can determine an accuracy of each of the trained AI models 232A-N based on the corresponding sets of features of the validation set. Where the training data may not include a target output, validating a trained AI model 232 may include obtaining an output from the AI model 232 and providing the output to another entity for evaluation. The other entity may include another AI model configured to evaluation the output of the AI model that is undergoing training. The other entity may include a human. The validation engine 216 can discard a trained AI model 232 that has an accuracy that does not meet a threshold accuracy or that otherwise fails evaluation. In some implementations, the selection engine 218 is capable of selecting a trained AI model 232 that has an accuracy that meets a threshold accuracy. In some implementations, the selection engine 218 is capable of selecting the trained AI model that has the highest accuracy of multiple trained AI models 232A-N. In some implementations, the selection engine 218 obtains input from another AI model or a human and can select a trained AI model 232 based on the input.

The testing engine 220 can be capable of testing a trained AI model 232 using a corresponding set of features of a testing set from the training data engine 212. For example, a first trained AI model 232 that was trained using a first set of features of the training set may be tested using the first set of features of the testing set. The testing engine 220 can determine a trained AI model 232 that has the highest accuracy or other evaluation of all of the trained AI models 232A-N based on the testing sets.

In some implementations, the AI model subsystem 230 selects an AI model 232 from the one or more AI models 232A-N. Selecting an AI model 232 may include selecting the AI model 232 for training or for use. For example, the training subsystem 210 can provide data to the AI model subsystem 230 indicating which AI model 232 is to be trained. The AI model subsystem 230 can obtain data from a component of the computing platform 120 (e.g., the metric selection subsystem 122) indicating which AI model 232 to use to generate an output.

FIG. 3 depicts one implementation of an AI inference subsystem 124. The AI inference subsystem 124 may include the AI model subsystem 230, which may include one or more AI models 232A-N. The AI inference subsystem 124 may include an input/output component 310. The input/output component 310 may be configured to feed data as input to an AI model 232, obtain one or more outputs from the AI model 232, and provide the one or more outputs to another component (e.g., the metric selection subsystem 122). For example, in the present disclosure, the input/output component 310 can feed one or more categories of entities or one or more metrics as input to the AI model 232 and obtain one or more outputs.

In some implementations, the AI inference subsystem 124 is not part of the metric selection subsystem 122 and may, instead, be part of another system or sub-system or be an independent system. In some implementations, the AI inference subsystem 124 includes the AI training subsystem 200.

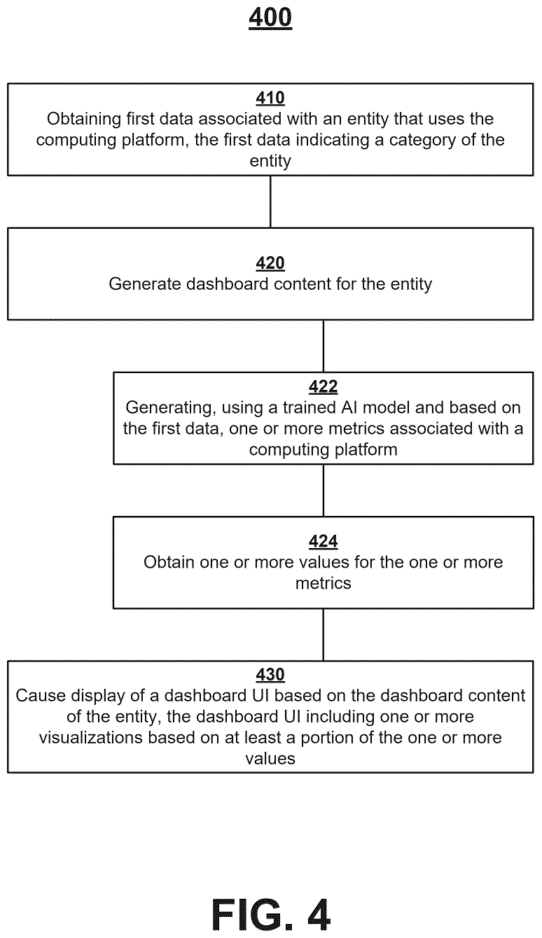

FIG. 4 is a flowchart illustrating one embodiment of a method 400 for generating computing platform dashboards using AI, in accordance with some implementations of the present disclosure. A processing device, having one or more central processing units (CPU(s)), one or more graphics processing units (GPU(s)), and/or memory devices communicatively coupled to the one or more CPU(s) and/or GPU(s) can perform the method 400 and/or one or more of the method's 400 individual functions, routines, subroutines, or operations. In certain implementations, a single processing thread can perform the method 400. Alternatively, two or more processing threads can perform the method 400, each thread executing one or more individual functions, routines, subroutines, or operations of the method. In an illustrative example, the processing threads implementing the method 400 can be synchronized (e.g., using semaphores, critical sections, and/or other thread synchronization mechanisms). Alternatively, the processing threads implementing the method 400 can be executed asynchronously with respect to each other. Various operations of the method 400 can be performed in a different (e.g., reversed) order compared with the order shown in FIG. 4. Some operations of the method 400 can be performed concurrently with other operations. Some operations can be optional. In some implementations, the metric selection subsystem 122 or the data visualization subsystem 128 can perform one or more operations of the method 400.

At block 410, processing logic obtains, at the computing platform 120, first data. The first data may be associated with an entity that uses the computing platform 120. The first data may indicate a category of the entity.

Obtaining the first data may include the computing platform 120 obtaining the first data from a client device of a user of the platform 120. The user may be associated with the entity. For example, the user may include an employee of the entity, and the user may access the platform 120 for the purpose of generating visualizations based on the entity's data in order to gain insights into the entity's data.

The category of the entity may indicate a classification that describes how the entity operates, how the entity is organized, what types of data the entity uses, or the like. The category may be general or granular. Examples of entity categories that may be general may include retail, services, government, educational, or the like. More granular examples of entity categories may include e-commerce, brick-and-mortar store, banking, cloud services, a police department, a university, a secondary education school, or the like.

In some implementations, the first data includes a role of the user associated with the entity. A role may include the user's position at the entity (e.g., chief executive officer (CEO), chief financial officer (CFO), network administrator, data analyst, or the like).

In one or more implementations, the first data includes one or more metrics. The one or more metrics may include a metric associated with the computing platform 120. A metric being associated with the computing platform 120 may include the platform 120 storing data (e.g., in the data store 126) that corresponds to the metric or that the platform 120 can use to derive the metric. For example, the metric may include a number of unique visitors to a website within the last hour, the platform 120 can store data indicating specific instances of devices accessing the website (e.g., Internet Protocol (IP) addresses and time of visit), and the platform 120 can use the data to calculate the number of unique visitors to the website within the last hour.

In one implementation, the user of the computing platform 120 may input the category of the entity into a UI provided by the client device. The user may input the user's role into the UI. The user may input one or more metrics into the UI. The UI may provide the input, as at least a portion of the first data, to the platform 120. In some implementations, the platform 120 can determine the entity associated with the user based on the identity of the user, and the platform 120 can obtain at least a portion of the first data from the data store 126.

At block 420, processing logic generates dashboard content for the entity. Dashboard content may include one or more visualizations, the arrangement of the one or more visualizations on a UI, or other dashboard-related content. Generating the dashboard content may include more operations of blocks 422 and 424, discussed below.

At block 422, processing logic generates one or more metrics associated with the computing platform 120. Generating the one or more metrics may include using a trained AI model 232 and may be based on the first data. It should be noted that, as used herein, the term “generating one or more metrics” includes selecting one or more metrics from one or more already-existing metrics.

In some implementations, the trained AI model 232 includes a generative AI model 232. As indicated above, in some implementations, the AI model 232 includes an LLM. In some implementations, the LLM includes generative AI functionality. In such implementations, the AI model 232 generates new content based on provided input data (e.g., the first data) and/or prompt data. In some implementations, the LLM is configured to generate one or more metrics associated with the computing platform 120.

The AI training subsystem 200 of FIG. 2 can be configured to train the LLM. It should be noted that the AI training subsystem 200 can train an LLM in accordance with implementations described herein or in accordance with other techniques for training LLMs. For example, an LLM may be trained on a large amount of data, including prediction of one or more missing words in a sentence, identification of whether two consecutive sentences are logically related to each other, generation of next texts based on prompts, etc. In some implementations, the AI training subsystem 200 is configured to train an LLM on a corpus of data that includes categories of entities, user roles, and metrics.

The generative AI model 232 can be supported by a prompt subsystem, which can reside on the computing platform 120. The prompt subsystem can enable a user or a component of the platform 120 to access the generative AI model 232. The prompt subsystem may be configured to perform automated identification of, and facilitate retrieval of, relevant and timely contextual information for efficient and accurate processing of prompts by the AI model 232. Communications between the prompt subsystem and the input/output component 310 may be facilitated by a generative model application programming interface (API), in some implementations. Communications between the prompt subsystem and the metric selection subsystem 122 may be facilitated by a data management API. In additional or alternative implementations, the generative model API translates prompts generated by the prompt subsystem into unstructured natural-language format and, conversely, translates responses received from the AI model 232 into any suitable form (e.g., including any structured proprietary format as may be used by the prompt subsystem). Similarly, the data management API can support instructions that may be used to communicate data requests to the metric selection subsystem 122 and formats of data received from such components.

A user can interact with the prompt subsystem via a prompt interface. The prompt interface may include a UI element that can support any suitable types of user inputs (e.g., textual inputs, speech inputs, image inputs, etc.). The UI element can further support any suitable types of outputs (e.g., textual outputs, speech outputs, image outputs, etc.). In some implementations, the UI element is a web-based UI element, a mobile application-supported UI element, or any combination thereof. The UI element includes selectable items that, in some implementations, enables a user to select from multiple generative AI models 232A-N. The UI element can allow the user to provide consent for the prompt subsystem or the generative AI model 232 to access user data or other data associated with a client device stored in the data store 126, process, or store new data received from the user, and the like. The UI element can additionally or alternatively allow the user to withhold consent to provide access to user data. In some implementations, user input entered using the UI element is communicated to the prompt subsystem by a user API. The user API can be located at the client device of the user accessing the query tool.

In some implementations, the prompt subsystem includes a prompt analyzer to support various operations of the present disclosure. For example, the prompt analyzer can receive an input (e.g., a prompt submitted by a user of or component of the computing platform 120) and generate one or more intermediate prompts to the generative AI model 232 to determine what type of data the generative AI model 232 may need to successfully respond to the input. Upon receiving a response from the generative AI model 232, the prompt analyzer can analyze the response, form a request for relevant contextual data for the data store 126, which can then supply such data. The prompt analyzer can then generate a prompt to the generative AI model 232 that includes the original prompt and the contextual data. In some implementations, the prompt analyzer, itself, includes a lightweight generative AI model that can process the intermediate prompt(s) and determine what type of contextual data may be needed by the generative AI model 232 together with the original prompt to ensure a meaningful response from generative AI model 232.

The prompt subsystem may include (or may have access to) instructions stored on one or more tangible, machine-readable storage media of a computing device (e.g., a computing device of the computing platform 120) and executable by one or more processing devices of the computing device. In one implementation, the prompt subsystem is implemented on a single machine. In some implementations, the prompt subsystem is combination of a client component and a server component. In some implementations, the prompt subsystem is executed entirely on a client device Alternatively, some portion of the prompt subsystem may be executed on a client computing device while another portion of the query tool may be executed on a server machine.

In some implementations, block 422 includes inputting a generative AI prompt into a generative AI model 232. The generative AI prompt may include a command for the generative AI model to generate the one or more metrics. The generative AI prompt may include a role of the user associated with the entity. The generative AI prompt may include one or more example metrics associated with the computing platform, as indicated by the first data. As an example, the generative AI prompt may include “User Role: CFO—Example Metrics: new vs. returning customers, average shopping cart spend, revenue—Task: Generate one or more metrics for use in a dashboard UI.” In some implementations, the AI model 232 includes a DNN.

In one implementation, generating, using the trained AI model 232, the one or more metrics includes selecting, based on the category of the entity, a trained AI model 232A from one or more trained AI models 232A-N and then using the selected trained AI model to generate the one or more metrics. The AI inference subsystem 124 may include an AI model 232 for each category of entity. For example, a first AI model 232A may correspond to e-commerce entities, a second AI model 232B may correspond to finance entities, and so on. The metric selection subsystem 122 can provide, to the input/output component 310 of the AI inference subsystem 124 the first data, and the input/output component 310 can select an AI model 232 based on the category of entity indicated by the first data. The input/output component 310 can then input other portions of the first data (e.g., the user role, the example metrics) into the selected AI model 232, and the AI model 232 can generate the one or more output metrics.

In some implementations, the AI model 232 uses, as input, the category of the entity. Where the AI model 232 includes an LLM, the generative AI prompt may include, either as context or as part of the prompt itself, the category of the entity, as indicated by the first data. As an example, the generative AI prompt may include “Entity Type: e-commerce—User Role: CFO-Example Metrics: new vs. returning customers, average shopping cart spend, revenue—Task: Generate one or more metrics for use in a dashboard UI.”

At block 424, processing logic obtains one or more values for the one or more metrics associated with the computing platform 120. Obtaining the one or more values may include using the data store 126. The one or more values may correspond to the entity of block 410.

The one or more values corresponding to the entity may include the values pertaining to the entity and not to a different entity. In some implementations, the data store 126 may store data for multiple entities in the same data store location (e.g., database table, file system folder, etc.), and the data store 126 may segregate the data pertaining to different entities. For example, where the data store 126 includes a database, the data store 126 may use row-level security (RLS) or other data access control techniques.

In one implementation, obtaining one or more values for the one or more metrics may include the metric selection subsystem 122 generating one or more data retrieval requests based on the one or more metrics. A data retrieval request may include an operation provided to the data store 126 that causes the data store 126 to provide data to the metric selection subsystem 122. For example, where the data store 126 includes a database, a data retrieval request may include a database query. Thus, obtaining, using the data store 126, the one or more values for the metrics associated with the computing platform 120 may include executing one or more queries on the database. The one or more queries may include the at least a portion of the plurality of metrics.

In some implementations, the metric selection subsystem 122 may include a database query template library. The database query template library may include one or more database query templates. A database query template may include an incomplete database query (e.g., the table may not be included, a column may not be included, or a conditional value May not be included). The metric selection subsystem 122 can use the one or more metrics generated by the AI model 232 to complete one or more database query templates and use the one or more database queries to obtain the one or more values.

In one or more implementations, the metric selection subsystem 122 can generate a generative AI prompt that includes a command to generate one or more data retrieval requests based on the one or more metrics. The metric selection subsystem 122 can provide the generative AI prompt to the prompt subsystem, which can then provide the prompt to a generative AI model 232. The generative AI model 232 may include a generative AI model trained on a corpus of data retrieval requests.

At block 430, processing logic causes display of a dashboard UI of the computing platform 120 based on the dashboard content for the entity. The dashboard UI may include one or more visualizations. Each visualization may be based on at least a portion of the one or more of values.

In some implementations, causing the display of the dashboard UI of the platform 120 may include displaying the dashboard UI on a client device that the user utilizes to access the platform 120. In one or more implementations, a visualization includes a graph, chart, table, or some other way to visualize the values of block 424. Each visualization may be based on a metric of the one or more metrics generated in block 422.

In some implementations, the method 400 may repeat blocks 424 and 430 in order to update the dashboard UI with updated values. Blocks 424 and 430 may repeat in response to a predetermined amount of time elapsing (e.g., every five minutes while the dashboard UI is being displayed to the user) or may repeat in response to a certain action (e.g., the user accesses the dashboard UI or the user interacts with a “refresh” UI element of the dashboard UI).

The following is an example implementation of the method 400. A user uses a client device to access the computing platform 120. The user is a market research analyst for an e-commerce entity. The computing resources 110 of the e-commerce company have not yet started providing data to the computing platform 120. The user may not know what data the user should use to visualize in order to help the user gain insights into the entity's data.

Continuing the example, the platform 120 causes the display of a UI for the platform 120 on the client device. The UI includes one or more UI elements where the user can input the category of the entity associated with the user, the user's role at the entity, or one or more example metrics. The user inputs, into the one or more UI elements, the entity category (e-commerce), the user's role (market research analyst), and some example metrics (average shopping cart spend and revenue for each month for the past six months). At block 410 of the method 400, the UI provides the inputs to the metric selection subsystem 122 to be used as the first data.

Continuing the example, at block 420, the metric selection subsystem 122 generates dashboard contents for the e-commerce entity. At block 422, the metric selection subsystem 122 provides the first data to the AI inference subsystem 124. The input/output component 310 of the AI inference subsystem 124 provides a generative AI prompt to the generative AI model 232 based on the first data. The prompt includes “Entity Type: e-commerce—Role: market research analyst—Example Metrics: average shopping cart spend and revenue for each month for the past six months-Task: Generate one or more metrics for use in a dashboard UI.” The generative AI model 232 obtains the prompt and executes based on the prompt. The generative AI model 232 outputs the metrics “average shopping cart spend, revenue for each month for the past six months, new vs. returning customers, shopping cart abandonment rate, social media sales conversions, and customer locations.”

Continuing the example, at block 424, the metric selection subsystem 122 obtains the metrics generated by the generative AI model 232. The metric selection subsystem 122 generates database queries based on the metrics. However, since the entity's computing resources may not have yet provided data to the computing platform 120, the metrics selection subsystem 122 can wait to proceed. Responsive to obtaining data from the computing resources 110, the metric selection subsystem 122 causes the data store 126 to execute the database queries, and the metric selection subsystem 122 obtains values that correspond to the e-commerce entity for the metrics. At block 430, the metric selection subsystem 122 provides the metrics and values to the data visualization subsystem 128. The data visualization subsystem 128 generates visualizations based on the metrics and values and causes the display of a dashboard UI on the user's client device.

Continuing the example, the dashboard UI includes a visualization for each metric based on the values corresponding to the respective metric. For the average shopping cart spend metric, the dashboard UI includes a visualization of a text box with a monetary value. For the revenue for each month for the past six months, the dashboard UI includes a visualization of a line chart. For the customer locations metric, the dashboard UI includes a map that includes different colors indicating the number of customers in each location.

In some implementations, the method 400 may further include retraining the trained AI model 232. The method 400 may further include generating, using the retrained AI model and based on the first data, a second one or more metrics associated with the computing platform 120. The second one or more metrics may include at least some different metrics from the one or more metrics of the block 422. The method 400 may further include repeating blocks 424 and 430 using the second one or more metrics to cause display of the dashboard UI with at least some different visualizations.

The computing platform 120 can cause the retraining of an AI model 232 in order to update the model with new training data. Newer training data may reflect newly discovered trends in metrics that users may find helpful. For example, it may be discovered that a high number of website visits from a certain geographic location may indicate a security threat. The AI model 232 may be retrained on training data that reflects this information. The metric selection subsystem 122 may then use the retrained AI model 232 to generate one or more metrics, and at least some of the one or more metrics may include number of website visitors from the geographic location. The metric selection subsystem 122 can obtain one or more values for the new metrics and provide the one or more values to the data visualization subsystem 128. The data visualization subsystem can cause the dashboard UI to display a new visualization based on the new metric and corresponding values. In this manner, the dashboard UI may constantly update to display relevant metrics to the user, even if the user was previously unaware of the relevancy of the new metrics.

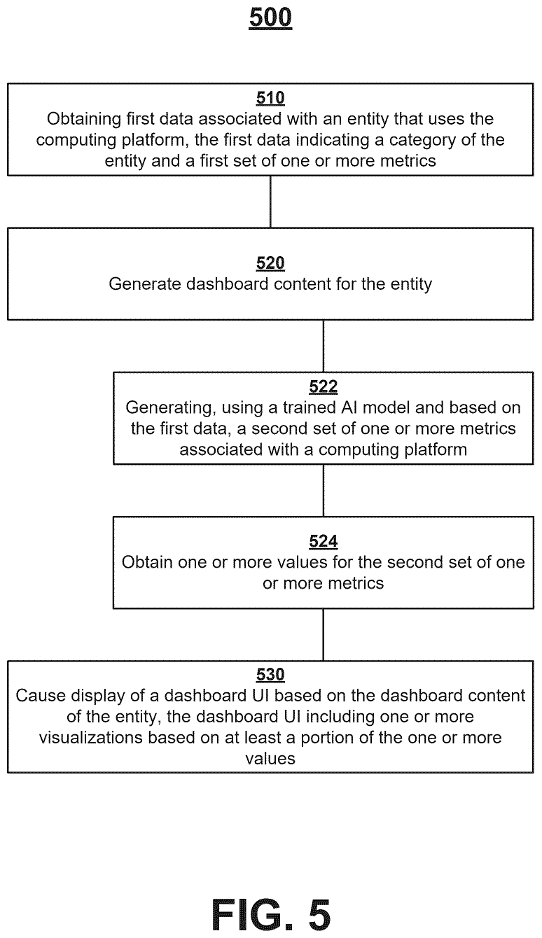

FIG. 5 is a flowchart illustrating one embodiment of a method 500 for generating computing platform dashboards using AI, in accordance with some implementations of the present disclosure. A processing device, having one or more CPU(s), one or more GPU(s), and/or memory devices communicatively coupled to the one or more CPU(s) and/or GPU(s) can perform the method 500 and/or one or more of the method's 500 individual functions, routines, subroutines, or operations. In certain implementations, a single processing thread can perform the method 500. Alternatively, two or more processing threads can perform the method 500, each thread executing one or more individual functions, routines, subroutines, or operations of the method. In an illustrative example, the processing threads implementing the method 500 can be synchronized (e.g., using semaphores, critical sections, and/or other thread synchronization mechanisms). Alternatively, the processing threads implementing the method 500 can be executed asynchronously with respect to each other. Various operations of the method 500 can be performed in a different (e.g., reversed) order compared with the order shown in FIG. 5. Some operations of the method 500 can be performed concurrently with other operations. Some operations can be optional. In some implementations, the metric selection subsystem 122 or the data visualization subsystem 128 can perform one or more operations of the method 500.

At block 510, processing logic obtains, at the computing platform 120, first data associated with an entity that uses the computing platform 120. The first data may indicate a category of the entity. The first data may indicate a first set of one or more metrics associated with the computing platform 120. Block 510 may include functionality similar to the functionality of block 410 of the method 400 of FIG. 4.

In some implementations, the first set of one or more metrics may include one or more example metrics. The user may provide the one or more example metrics. The user may know some metrics the user may be interested in visualizing but may need assistance in determining what additional metrics may be helpful for the user.

At block 520, processing logic generates dashboard content for the entity. Generating the dashboard content may include one or more operations, discussed below. At block 522, processing logic generates, using a trained AI model 232 and based on the first data, a second set of one or more metrics associated with the computing platform 120. Block 522 may include functionality similar to the functionality of block 422 of the method 400.

In one implementation, the first set of one or more metrics and the second set of one or more metrics include at least one common metric. Otherwise, the user may become confused if the user initially inputs one or more example metrics in block 410 but no visualization based on any of those example metrics are included in the dashboard UI. In some implementations, all of the metrics in the first set of one or more metrics are included in the second set of one or more metrics.

At block 524, processing logic obtains, using the data store 126 of the computing platform 120, one or more values for the second set of one or more metrics associated with the computing platform 120. The one or more values may correspond to the entity. Block 524 may include functionality similar to the functionality of block 424 of the method 400.

At block 530, processing logic causes display of a dashboard UI of the computing platform 120 based on the dashboard content for the entity. The dashboard UI may include one or more visualizations, and each visualization may be based on at least a portion of the one or more of values. Block 530 may include functionality similar to the functionality of block 430 of the method 400.

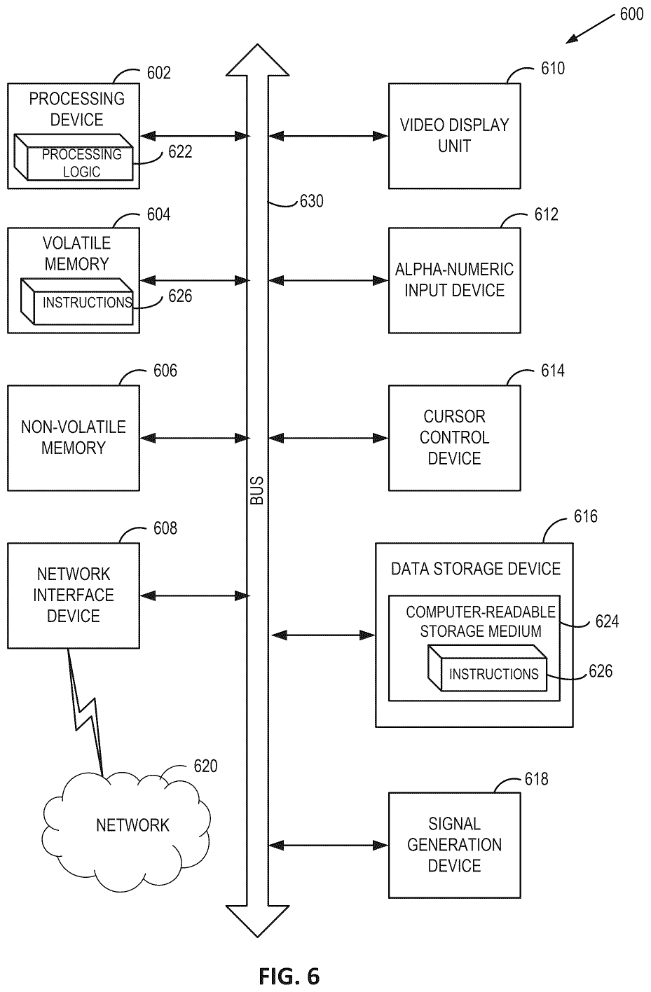

FIG. 6 is a block diagram illustrating an example computer system 600, in accordance with implementations of the present disclosure. The computer system can be a computing device or other device discussed herein. The computer system 600 can be a computing device of the computing platform 120, the metric selection subsystem 122, the AI inference subsystem 124, the data store 126, or the data visualization subsystem 128 of FIG. 1 or the AI training subsystem 200 of FIG. 2. The computer system 600 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a volatile memory 604 (e.g., read-only memory (ROM), flash memory, dynamic random access memory (DRAM) such as synchronous DRAM (SDRAM), double data rate (DDR SDRAM), or DRAM (RDRAM), etc.), a non-volatile memory 606 (e.g., flash memory, static random access memory (SRAM), etc.), and a data store device 616, which communicate with each other via a bus 630.

The processing device 602 represents one or more general-purpose processing devices such as a microprocessor, CPU, GPU, or the like. More particularly, the processing device 602 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 can also be one or more special-purpose processing devices such as an ASIC, a field programmable gate array (FPGA), a digital signal processor (DSP), network processor, or the like. The processing device 602 is configured to execute instructions 626 (e.g., for performing one or more of the methods 400 or 500) for performing the operations discussed herein.

The computer system 600 can further include a network interface device 608. The network interface device 608 can assist in data communication between computing devices. The computer system 600 also can include a video display unit 610 (e.g., a liquid crystal display (LCD) or a cathode ray tube (CRT)), an input device 612 (e.g., a keyboard, and alphanumeric keyboard, a motion sensing input device, touch screen), a cursor control device 614 (e.g., a mouse), and a signal generation device 618 (e.g., a speaker).

The data store device 616 can include a non-transitory machine-readable storage medium 624 (also computer-readable storage medium) on which is stored one or more sets of instructions 626. The instructions may embody any one or more of the methodologies or functions described herein. The instructions 626 can also reside, completely or at least partially, within the volatile memory 604 and/or within the processing device 602 during execution thereof by the computer system 600, the volatile memory 604 and the processing device 602 also constituting machine-readable storage media. The instructions 626 can further be transmitted or received over a network 620 via the network interface device 608.

In one implementation, the instructions 626 include instructions for generating computing platform dashboards using AI. While the computer-readable storage medium 624 (machine-readable storage medium) is shown in an example implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure can be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “obtaining”, “generating”, “causing”, “using”, “providing”, “inputting”, “selecting”, “executing”, “displaying”, “moving”, “adjusting”, “replacing”, “determining”, “playing”, “configuring”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

For simplicity of explanation, the methods 400 and 500 are depicted and described herein as a series of acts. However, acts in accordance with this disclosure can occur in various orders and/or concurrently, and with other acts not presented and described herein. Furthermore, not all illustrated acts can be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Certain implementations of the present disclosure also relate to an apparatus for performing the operations herein. This apparatus can be constructed for the intended purposes, or it can comprise a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one implementation,” “an implementation,” “some implementations,” “one embodiment,” “an embodiment,” or “some embodiments” mean that a particular feature, structure, or characteristic described in connection with the implementation or embodiment is included in at least one implementation or embodiment. Thus, the appearances of the phrase “in one implementation” or “in an implementation” or other similar terms in various places throughout this specification are not necessarily all referring to the same implementation. In addition, the term “or” is intended to mean an inclusive “or” rather than an exclusive “or.” Moreover, the word “example” or a similar term are used herein to mean serving as an example, instance, or illustration. Any aspect or design described herein as an “example” is not necessarily to be construed as preferred or advantageous over other aspects or designs. Rather, use of the word “example” or a similar term is intended to present concepts in a concrete fashion.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
obtaining, at a computing platform, first data associated with an entity that uses the computing platform, wherein the first data indicates a category of the entity; and
generating dashboard content for the entity, wherein the generating comprises:
generating, using a trained artificial intelligence (AI) model and based on the first data, a plurality of metrics associated with the computing platform, and
obtaining, using a data store of the computing platform, a plurality of values for the plurality of metrics associated with the computing platform, wherein the plurality of values corresponds to the entity; and
causing display of a dashboard user interface (UI) of the computing platform based on the dashboard content for the entity, wherein the dashboard UI comprises one or more visualizations each based on at least a portion of the plurality of values.

2. The method of claim 1, wherein the trained AI model comprises a generative AI model.

3. The method of claim 2, wherein:
generating, using the trained AI model and based on the first data, the plurality of metrics associated with the computing platform comprises inputting a generative AI prompt into the generative AI model; and
the generative AI model prompt includes a command for the generative AI model to generate the plurality of metrics.

4. The method of claim 3, wherein the generative AI model prompt further includes a context comprising the category of the entity.

5. The method of claim 3, wherein the generative AI model prompt further includes a context comprising a plurality of example metrics associated with the computing platform.

6. The method of claim 1, wherein the trained AI model comprises a deep neural network (DNN).

7. The method of claim 1, wherein the first data further indicates a role of a user of the entity that uses the computing platform.

8. The method of claim 1, wherein generating, using the trained AI model and based on the first data, the plurality of metrics associated with the computing platform comprises:
selecting, based on the category of the entity, the trained AI model from a plurality of trained AI models; and
using the trained AI model to generate the plurality of metrics.

9. The method of claim 1, wherein:
the data store comprises a database; and
obtaining, using the data store, the plurality of values for the metrics associated with the computing platform comprises executing one or more queries on the database, wherein the one or more queries comprise the at least a portion of the plurality of metrics.

10. The method of claim 1, further comprising training the AI model on training data, wherein the training data is based on metrics associated with the computing platform for a plurality of entities that use the computing platform.

11. A system, comprising:
a memory; and
a processor device, coupled to the memory, configured to perform operations, comprising:
obtaining, at a computing platform, first data associated with an entity that uses the computing platform, wherein the first data indicates a category of the entity, and
generating dashboard content for the entity, wherein the generating comprises:
generating, using a trained artificial intelligence (AI) model and based on the first data, a plurality of metrics associated with the computing platform, and
obtaining, using a data store of the computing platform, a plurality of values for the plurality of metrics associated with the computing platform, wherein the plurality of values corresponds to the entity; and
causing display of a dashboard user interface (UI) of the computing platform based on the dashboard content for the entity, wherein the dashboard UI comprises one or more visualizations each based on at least a portion of the plurality of values.

12. The system of claim 11, wherein the computing platform comprises a security analytics platform.

13. The system of claim 11, wherein the trained AI model comprises a generative AI model.

14. The system of claim 13, wherein:
generating, using the trained AI model and based on the first data, the plurality of metrics associated with the computing platform comprises inputting a generative AI prompt into the generative AI model; and
the generative AI model prompt includes a command for the generative AI model to generate the plurality of metrics.

15. The system of claim 14, wherein the generative AI model prompt further includes a context comprising a plurality of example metrics associated with the computing platform.

16. The system of claim 11, wherein the trained AI model comprises a deep neural network (DNN).

17. The system of claim 11, wherein generating, using the trained AI model and based on the first data, the plurality of metrics associated with the computing platform comprises:
selecting, based on the category of the entity, the trained AI model from a plurality of trained AI models; and
using the trained AI model to generate the plurality of metrics.

18. A method, comprising:
obtaining, at a computing platform, first data associated with an entity that uses the computing platform, wherein the first data indicates:
a category of the entity, and
a first plurality of metrics associated with the computing platform; and
generating dashboard content for the entity, wherein the generating comprises:
generating, using a trained artificial intelligence (AI) model and based on the first data, a second plurality of metrics associated with the computing platform, and
obtaining, using a data store of the computing platform, a plurality of values for the second plurality of metrics associated with the computing platform, wherein the plurality of values corresponds to the entity; and
causing display of a dashboard user interface (UI) of the computing platform based on the dashboard content for the entity, wherein the dashboard UI comprises one or more visualizations each based on at least a portion of the plurality of values.

19. The method of claim 18, wherein the first plurality of metrics and the second plurality of metrics comprise at least one common metric.

20. The method of claim 18, wherein the first plurality of metrics comprises a number of unique visitors to a website of the entity that uses the computing platform.
